(19) United States
(12) Patent Application Publication
(10) Pub. No.: US 2013/0183104 A1
(43) Pub. Date: Jul. 18, 2013

(54) RETAINING WALL BLOCKS WITH BUILT-IN DRAINAGE AND FILTRATION SYSTEM

(71) Applicant: Rick Steven Louie, Los Gatos, CA (US)

(72) Inventor: Rick Steven Louie, Los Gatos, CA (US)

(21) Appl. No.: 13/414,682

(22) Filed: Mar. 7, 2012

Related U.S. Application Data
(60) Provisional application No. 61/586,243, filed on Jan. 13, 2012.

(51) Int. Cl. E02D 29/02; B01D 35/00; E04C 1/39

(52) U.S. Cl. 405/284; 52/503; 210/154

(57) ABSTRACT

A retaining wall block with built-in drainage and filtration capabilities is described. A simplified process for constructing retaining wall using these blocks is also disclosed. The blocks facilitate superior drainage by providing built-in drain conduits that provide numerous channels for water to drain though. The built-in filtration disclosed prevents erosion of the backfill and clogging of drainage channels. The described blocks offer a simpler way to address drainage, erosion and clogging issues of retaining wall, by eliminating several retention wall creation steps. The blocks also eliminate the need for separate drainage and filtration system, they also eliminate need for free-draining aggregate backfills, thus reducing the transportation and construction cost associated with these steps.

### CROSS-REFERENCE TO RELATED APPLICATIONS

This application claims the benefit of the following provisional applications, each of which is hereby incorporated by reference in its entirety: U.S. Pat. App. No. 61/586,243 filed on Jan. 13, 2012 and entitled “Retaining Wall Blocks with Built-in Drainage and Filtration System.”

### FIELD OF THE INVENTION

The present device relates generally to block retaining walls. More particularly, the present device relates to retaining wall blocks with built-in drainage and filtration system and a system for assembly of retaining walls with such blocks.

### BACKGROUND OF THE INVENTION

A retaining wall is a structure that holds back soil and rocks (backfill) and provides lateral support to vertical slopes of soil. Retaining walls have been used for purposes such as hillside erosion control, landscaping, and so forth. Retaining walls can be constructed of many different materials, such as stone, masonry, brick, concrete, vinyl, steel, or timber, and with a variety of building techniques. Segmental retaining walls assembled from modular blocks that interlock with each other and with the lateral restraining members, have gained favor over monolithic poured concrete walls as they are economical, easier to install and enable rapid construction.

Besides the soil pressure behind the retaining wall, due to retained material attempting to move forward and downslope by gravity, there can also be hydraulic pressure on the retaining wall if the groundwater behind the retaining wall is not dissipated by drainage system. Conventional retaining wall systems solve the drainage issue by layering free-draining aggregate behind the wall to channel water to a supplemental drainage system. In some cases, where water drainage needs are severe, sophisticated vertical as well as horizontal drain conduit (tiles) are needed. In some systems, filter fabric is used to retain wall backfill while allowing the water to pass through. Filter fabric also prevents free-draining aggregate from clogging.

As seen in conventional retaining wall systems, drainage, erosion and clogging issues have to be addressed separately then the basic assembly of layers of retaining blocks. Thus, it would be desirable to have retaining blocks with built-in drainage and filtration capability such that drainage, erosion and clogging issues are addressed just by appropriately assembling layers of these retaining blocks and thereby eliminating the need for various separate horizontal or vertical drain conduit system.

Another drawback of a conventional segmental retaining wall construction system is that it involves numerous steps. Some of the steps that are involved in construction of a conventional segmental retaining wall using concrete or stone blocks are as follows: site excavation, preparation and compaction, laying of compactable base (e.g. sand and gravel), laying of the first layer of blocks side-by-side in full contact with the base, backfilling with free-draining aggregate (e.g. gravel), placing of the filter fabric behind the free-draining aggregate, laying of additional layers of block in a running bond pattern, pulling each unit forward until secure, backfilling each additional course as it is installed with free-draining aggregate, placing drain tile behind the wall at grade to allow water to drain from the backfill, further backfilling with gravel, filling any remaining areas behind the walls with soil, continuing the steps until the wall reaches the desired height. Thus, there is a need to simplify the process of constructing segmental retaining wall, while still addressing drainage and soil erosion issues.

Yet another drawback of conventional segmental retaining wall construction system is that retaining wall building blocks (e.g. concrete or stone) as well as free-draining aggregate (e.g. gravel) are made of a relatively high-density material. Thus, they are quite heavy and difficult to lift and handle conveniently. They are also costly to transport. Thus, it is desirable to reduce the weight of material that needs to be transported for constructing a retention wall by either eliminating or reducing the need for free-draining aggregate, drainage tiles, and such.

There is an acute need for retaining blocks which have built in drainage and filtration capabilities such that drainage, erosion and clogging issues are addressed just by appropriately assembling layers of these retaining blocks. There is also an acute need to simplify retention wall construction process. There is a further need to reduce the weight and amount of material that needs to be transported for constructing a retention wall, thereby greatly increasing the cost-effectiveness of transportation and handling of material between the source and the work site.

Further, there is need for increasing the drainage capability of the retaining wall drainage system by providing drainage capabilities in the retaining wall blocks itself, thus, enabling one to accommodate much greater fluctuations in drainage flow due to heavy rains, thereby also greatly reducing the amount of ground excavation and preparation necessary prior to wall construction. There is also a need to increase the cost-effectiveness of overall construction of retaining wall and drainage system.

The retaining block with built-in drainage and filtering capability of present invention addresses all the above mentioned needs and problems. These and other features and advantages of the present invention will be explained and will become obvious to one skilled in the art through the summary of the invention that follows.

### SUMMARY OF THE INVENTION

Accordingly, a retaining wall block with built in drainage and filtration capabilities and a system for constructing retaining wall using these blocks is disclosed. The blocks facilitate superior drainage by providing built-in drain conduits that provide numerous channels for water to drain though. The built-in filtration disclosed, prevents erosion of the backfill and clogging of drainage channels. The disclosed blocks eliminate the need for separate horizontal or vertical drain conduit and simplify the process of constructing a segmental retaining wall. They also eliminate or reduce the use of free-draining aggregate, thus reducing transportation cost. They further reduce excavation and preparation requirements, thus simplifying the process of constructing segmental retaining wall. In one embodiment of the device a retaining wall block formed of heavy, high-density material, typically concrete or stone, is joined to a light-weight, water-resistant material, such as polyvinyl chloride (PVC), wherein the light-weight material has one or more drainage channels built into it. The light-weight material is further covered by a filtration fabric such that erosion of the backfill and/or clogging of drainage channels are prevented.

According to an embodiment of the present invention, a retaining wall block with built-in drainage and filtration system includes a heavy member; a light member, connected to said heavy member and comprising a built-in network of drainage channels, wherein said built-in network of drainage channels are configured to facilitate drainage of water.

According to an embodiment of the present invention, the light member comprises a light weight, water resistant material.

According to an embodiment of the present invention, the light member comprises a material resistant to common roadway run-off and byproducts.

According to an embodiment of the present invention, the built-in network of drainage channels comprises one or more horizontal drainage channels.

According to an embodiment of the present invention, the built-in network of drainage channels comprises one or more vertical drainage channels.

According to an embodiment of the present invention, the built-in network of drainage channels comprises one or more horizontal drainage channels interconnected with said one or more vertical drainage channels

According to an embodiment of the present invention, the built-in network of drainage channels is configured to interlink with a built-in network of drainage channels of one or more adjacent retaining blocks.

According to an embodiment of the present invention, the retaining blocks are comprised of a filtration member that covers said light member and is configured to prevent clogging of said built-in network of drainage channels.

According to an embodiment of the present invention, the filtration member is further configured to prevent erosion of a backfill while allowing fluids to drain through the built-in network of drainage channels.

According to an embodiment of the present invention, a method for building a retaining wall with built-in drainage and filtration includes the steps of: providing a first plurality of retaining blocks, wherein each retaining block of said first plurality of retaining blocks has a built-in drainage and filtration system; engaging said first plurality of retaining blocks into a first layer, wherein each retaining block of said first plurality of retaining blocks is engaged in a manner such that the built-in drainage and filtration system of said retaining block is engaged with at least one of the other retaining blocks of said first plurality of retaining blocks; providing a second plurality of retaining blocks, wherein each retaining block of said second plurality of retaining blocks has a built-in drainage and filtration system; and layering one or more secondary layers onto of said first layer, wherein said one or more secondary layers are comprised of said secondary plurality of retaining blocks, wherein at least a portion of said retaining blocks of said second plurality of retaining blocks is layered in a manner such that the built-in drainage and filtration system of said retaining block is engaged with at least one of the other retaining blocks of said first plurality of retaining blocks, wherein each retaining block of said second plurality of retaining blocks is engaged in a manner such that the built-in drainage and filtration system of said retaining block is engaged with at least one of the other retaining blocks of said second plurality of retaining blocks.

According to an embodiment of the present invention, the method further comprises the step of backfilling at least a portion of said first plurality of retaining blocks with free-draining aggregate.

According to an embodiment of the present invention, the method further comprises the step of backfilling at least a portion of said second plurality of retaining blocks with free-draining aggregate.

According to an embodiment of the present invention, the method further comprises the step of filling an area behind the retaining wall with soil.

According to an embodiment of the present invention, a heavy member of each of said first plurality of retaining blocks is side-by-side engaged with a heavy member of another retaining block of said first plurality of retaining blocks.

According to an embodiment of the present invention, a light member of each of said first plurality of retaining blocks is side-by-side engaged with a light member of another retaining block of said first plurality of retaining blocks.

Other features and advantages of the present device will be apparent from the accompanying drawings, and from the detailed description, which follows below.

### BRIEF DESCRIPTION OF THE DRAWINGS

The present device is illustrated by way of example, and not limitation, in the figures of the accompanying drawings in which like reference numerals refer to similar elements and which:

FIG. 1 illustrates a retaining wall block with built in drainage and filtration capability according to an embodiment of the present device.

FIG. 2 illustrates an exemplary retaining wall being constructed by inter locking retaining wall blocks with built in drainage and filtration capability.

FIG. 3 illustrates a flow chart of the exemplary steps involved in construction of retaining wall using retaining blocks with built in drainage and filtration capability.

FIG. 4 illustrates a retaining wall block with built in drainage and filtration capability according to an embodiment of the present device.

FIG. 5 illustrates a retaining wall block with built in drainage and filtration capability according to another embodiment of the present device.

FIG. 5A illustrates a front elevation view of a retaining wall block with built in drainage and filtration capability according to an embodiment of the present device.

FIG. 5B illustrates a rear elevation view of a retaining wall block with built in drainage and filtration capability according to an embodiment of the present device.

FIG. 5C illustrates a cross sectional view of a retaining wall block with built in drainage and filtration capability according to an embodiment of the present invention.

FIG. 5D illustrates a top elevation view of a retaining wall block with built in drainage and filtration capability according to an embodiment of the present device.

FIG. 5E illustrates a side elevation view of a retaining wall block with built in drainage and filtration capability according to an embodiment of the present device.

FIG. 6 illustrates a front elevation view of a retaining wall block with built in drainage and filtration capability according to an embodiment of the present device.

FIG. 7 illustrates a rear elevation view of a retaining wall block with built in drainage and filtration capability according to an embodiment of the present device.

FIG. 8 illustrates a top elevation view of a retaining wall block with built in drainage and filtration capability according to an embodiment of the present device.

FIG. 9 illustrates a side elevation view of a retaining wall block with built in drainage and filtration capability according to an embodiment of the present device.

FIG. 10 illustrates a cross sectional view of a retaining wall block with built in drainage and filtration capability according to an embodiment of the present device.

FIG. 11 illustrates a perspective view of a retaining wall block with built in drainage and filtration capability according to an embodiment of the present device.

FIG. 12 illustrates a perspective view of a retaining wall block with built in drainage and filtration capability according to an embodiment of the present device.

FIG. 13 illustrates a perspective view of a wall cap component of a retaining wall block with built in drainage and filtration capability according to an embodiment of the present device.

FIG. 14 illustrates a perspective view of a corner block component of a retaining wall block with built in drainage and filtration capability according to an embodiment of the present device.

FIG. 15 illustrates a perspective view of a filler block component of a retaining wall block with built in drainage and filtration capability according to an embodiment of the present device.

FIG. 16 illustrates a cross sectional view of a drainage interior component of a retaining wall block with built in drainage and filtration capability according to an embodiment of the present device.

### DETAILED DESCRIPTION

A retaining wall block with built in drainage and filtration capabilities is disclosed. A simplified process for constructing a retaining wall using these blocks is also disclosed. The blocks can facilitate superior drainage by providing built-in drain conduits that provide numerous channels for water to drain though. The block's built-in filtration can prevent erosion of the backfill as well as clogging of drainage channels. The disclosed blocks can eliminate the need for separate horizontal or vertical drain conduit, as required for drainage in conventional retaining wall systems. They can also simplify the process of constructing a segmental retaining wall. The disclosed retaining blocks also can eliminate or reduce the use of free-draining aggregate, thus, reducing transportation cost. The blocks can further reduce excavation and preparation requirements, thus, simplifying the process of constructing a segmental retaining wall.

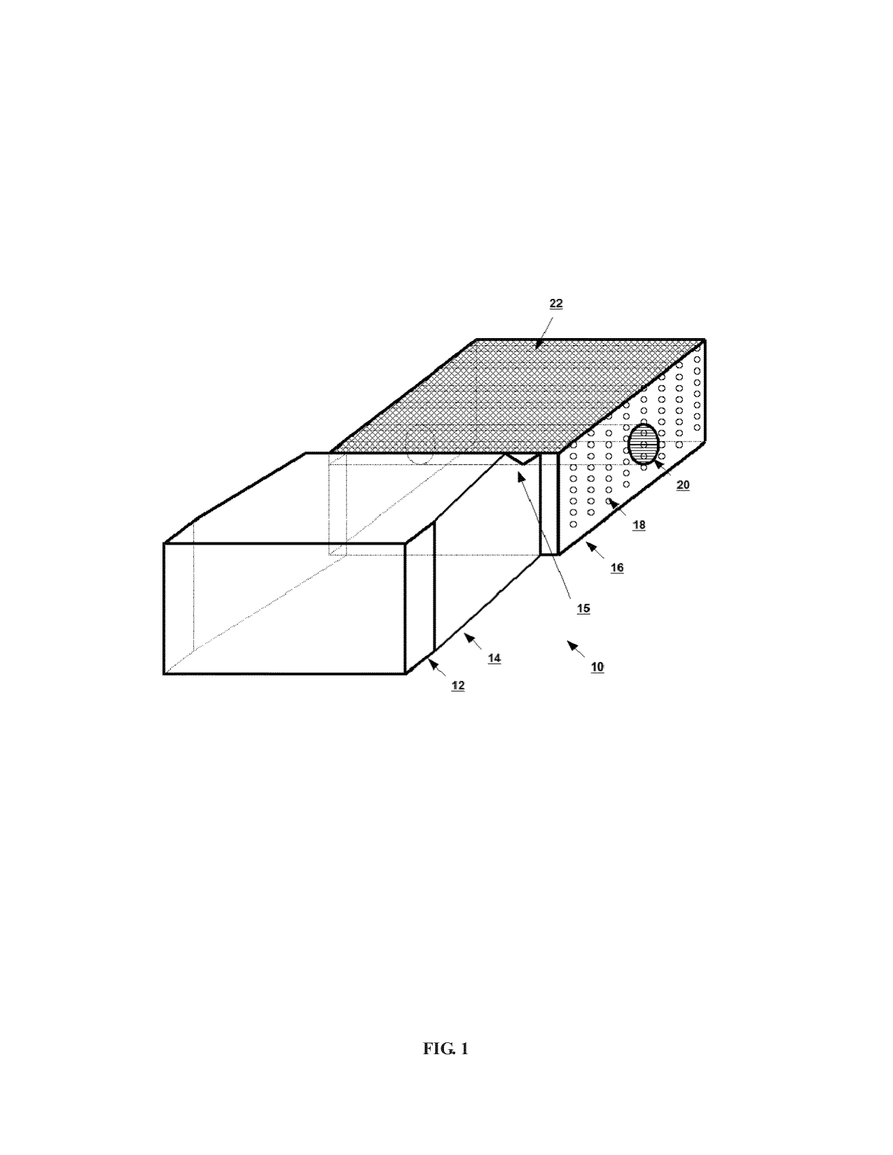

FIG. 1 illustrates a retaining wall block 10 with built in drainage and filtration capability according to an embodiment of the present device. It has a heavy member 12 made up of high-density material, typically concrete or stone, as is most common in the industry. The heavy member can be made in different forms and shapes, such that they can be stacked and engaged with one another such that a retaining wall is formed by arranging, side-by-side, a plurality of stacks of these retaining wall blocks. The illustrated heavy member has tapering vertical edges 14 as well as an engaging nudge 15 to facilitate stacking, drainage and engagement between different blocks of the retaining wall. The heavy member provides the strength to hold back soil and rocks.

The heavy member 12 can be connected to a light member 16, which can be made of any light weight, water resistant material, such as polyvinyl chloride (PVC). One of ordinary skill in the art would appreciate that there are numerous light weight, water resistant materials that could be utilized with embodiments of the present invention, and embodiments of the present invention are contemplated for use with any such material. In a preferred embodiment, the light weight, water resistant material would be a material that is also resistant to common roadway run-off byproducts (e.g., oils, salts, sand).

The light member (light-weight member) reduces the weight of the materials that would have to be transported for building the retaining wall. The light member can have built-in network of drainage channels 18 to facilitate drainage of water from behind the retaining wall. Thus, embodiments of the present invention work to avoid buildup of hydraulic pressure on the retaining wall. The network of drainage channels can be made of numerous interconnected horizontal and vertical channels, or of any other configuration that facilitate drainage. In the illustrated embodiment a combination of larger channels 20 and smaller channels 18 can be used for drainage. In one embodiment, the retaining block can be formed and arranged in such a way such that the drainage channels from one block interlink with drainage channels from adjacent blocks and thus, form a larger network of drainage channels with superior drainage capabilities than the conventional retaining wall system. In another embodiment of the device the drainage channels between the blocks might not get interlinked, but the arrangement of the blocks still facilitates efficient drainage from behind the retaining wall.

The light-weight member 16 can be further covered by a filtration member 22 which can be made up of filter fabric such as geotextiles or any other known and/or convenient material. The filtration member prevents clogging of drainage channels, while also preventing erosion of the backfill while allowing water to drain through the drainage channels.

The retaining wall block with built-in drainage and filtration system described above solves the drainage, erosion and clogging issues faced by retaining walls build from conventional blocks. They can also eliminate the need for providing separate horizontal and/or vertical drain conduit for drainage as drainage is built into the blocks. The blocks can also eliminate need for a separate filter fabric placement step as filtration is also built into the blocks. The described blocks also reduce the weight of material that will have to be transported to the retaining wall construction site, as they eliminate or reduce the need for free-draining aggregate (gravel). By providing superior drainage due to the filtration and network of drainage channels available for water to flow through, not as much excavation and preparation is required for building the retention wall as would be required for conventional retention wall. The described blocks simplify the process of constructing a segmental retaining wall and avoid hydraulic pressure build-up behind the retention wall.

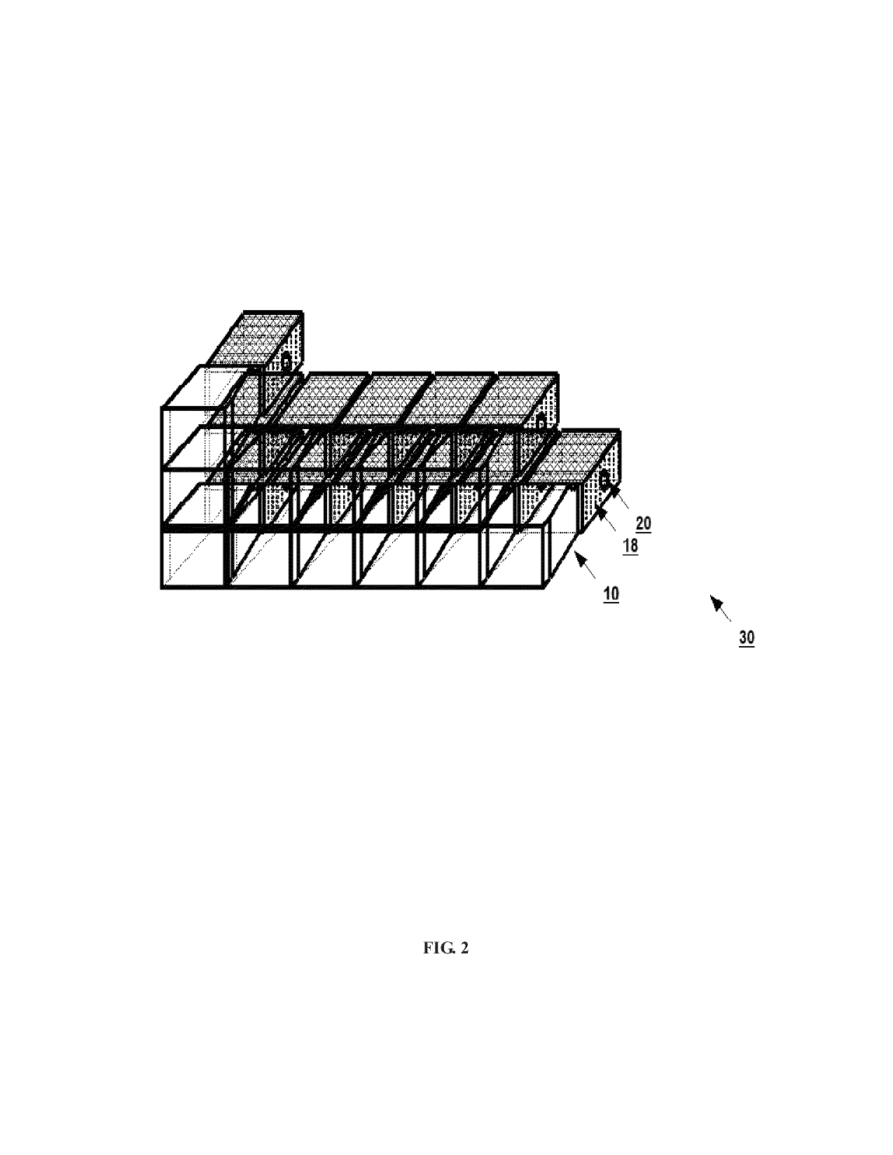

FIG. 2 illustrates an exemplary retaining wall 30 being constructed by interlocking retaining wall blocks 10 with built-in drainage 18, 20 and filtration capability. The retaining blocks can be stacked and engaged with one another such that a retaining wall is formed by arranging, side-by-side, a plurality of stacks of these retaining wall blocks. In one embodiment of the device, the stack can be slightly tapered towards the backfill in order to effectively hold back the backfill. Assembly of the blocks with built-in drainage and filtration provides the required drainage and filtration to the retaining wall, without the need for any special steps such as providing a separate drainage and filtration system.

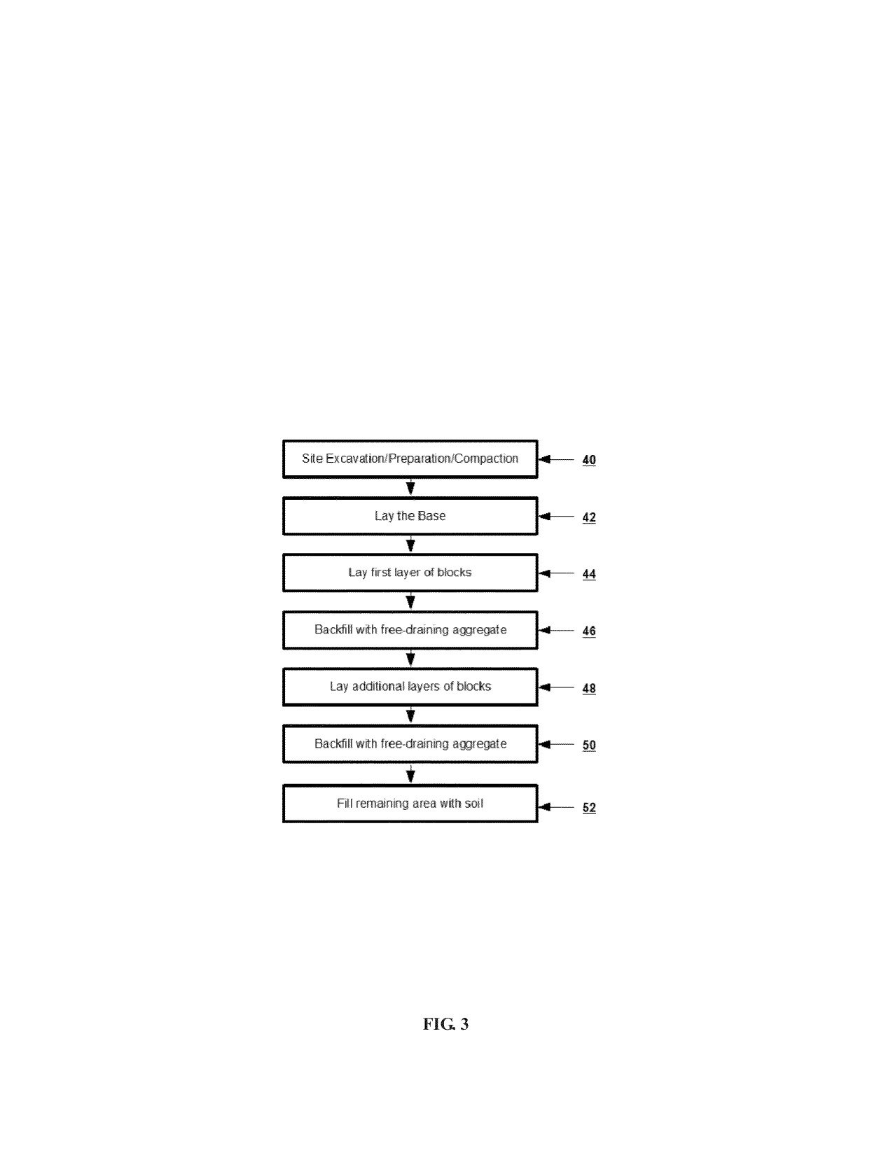

FIG. 3 illustrates a flow chart of the exemplary steps involved in construction of retaining wall using retaining blocks with built in drainage and filtration capability. At step 40, the site where retention wall is to be built is excavated, prepared and compacted. At step 42 a gravel base can be laid.

At step 44 first layer of blocks are laid such that they engage with one another. In one embodiment of the device only the heavy member of the side-by-side blocks engage with one another. In another embodiment of the device both the heavy as well as light member of the side-by-side blocks can engage with one another, forming a network of interconnected channels for drainage. At step 46, the first layer of blocks can optionally be backfilled with free-draining aggregate. In one embodiment of the device, no backfilling with free-draining aggregate is required. In another embodiment of the device, a reduced amount of free-draining aggregate is backfilled.

At step 48 other layers of blocks are stacked and engaged on top of the bottom layer of blocks. At step 50 the blocks are optionally backfilled with free-draining aggregate. Layers of blocks are stacked. At step 52 remaining area behind the retaining wall is filled with soil.

Steps for laying a separate drainage system using free-draining aggregate and drain tiles are eliminated. So is the step for laying a separate filtration system is eliminated. In some embodiments of the present device backfilling with free-draining aggregate step can also be eliminated. Besides, due to the superior drainage capabilities of the retaining blocks with built-in drainage and filtration capabilities, not as much excavation and preparation is required for building the retention wall as would be required for conventional retention wall. Thus, the present device reduces the number of steps required for building a retention wall, and simplifies the process, while at the same time providing superior drainage and filtration capabilities.

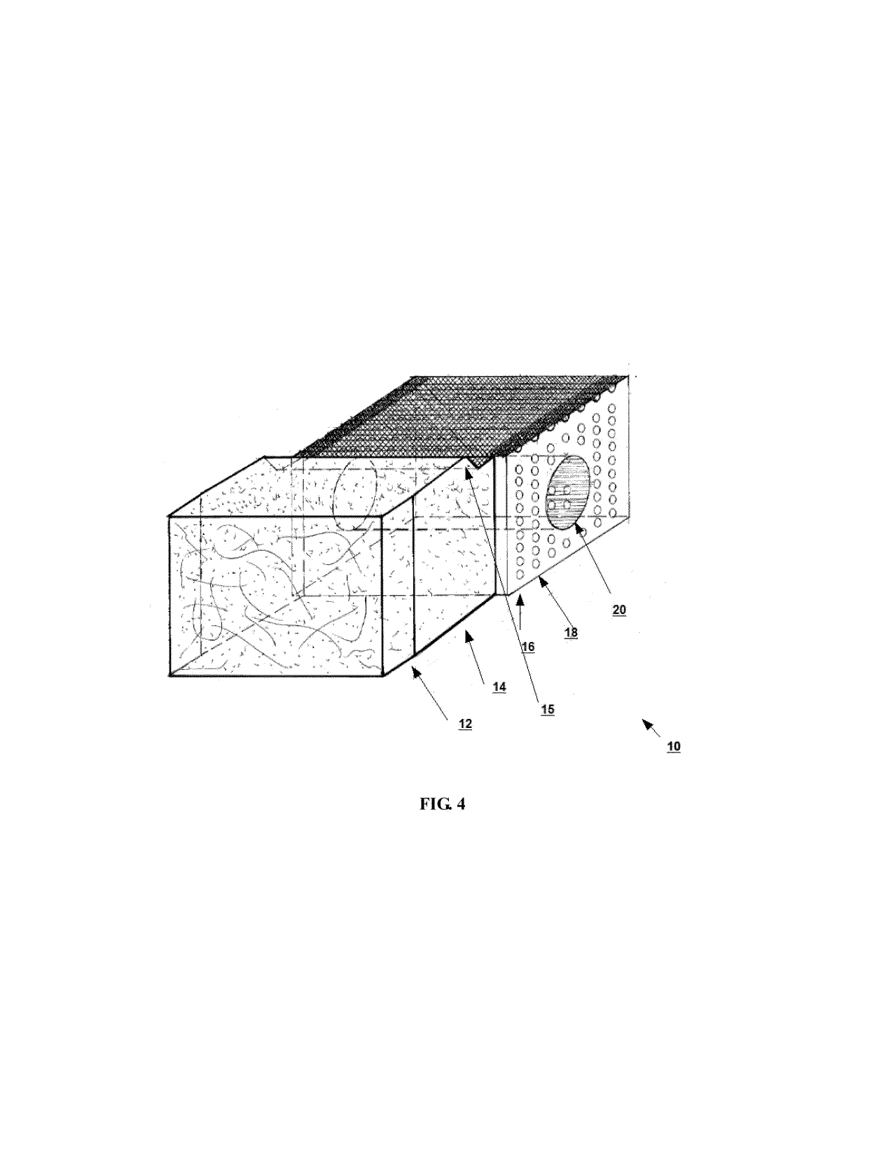

FIG. 4 illustrates a retaining wall block 10 with built in drainage and filtration capability according to an embodiment of the present device. It has a heavy member 12 made up of high-density material (e.g. concrete), which can be about 18″ wide and about 12″ deep and about 12″ high. The illustrated heavy member has tapering vertical edges 14 as well as an engaging nudge 15 which is about 1½″high and about 3″ deep, to facilitate stacking, drainage and engagement between different blocks of the retaining wall.

The heavy member 12 is connected to a light member 16, which can be made of any light weight, water resistant material, such as polyvinyl chloride (PVC) and can be about 18″ wide, about 12″ deep and about 10½″ high. One of ordinary skill in the art would appreciate that there are numerous light weight, water resistant materials that could be utilized with embodiments of the present invention, and embodiments of the present invention are contemplated for use with any such material. In a preferred embodiment, the light weight, water resistant material would be a material that is also resistant to common roadway run-off byproducts (e.g., oils, salts, sand).

The light member has built-in network of drainage channels 18 to facilitate drainage of water from behind the retaining wall. In the illustrated embodiment a combination of interconnected larger channels 20 and smaller channels 18 can be used for drainage. The light weight member 16 is further covered by a filtration member 22 which can be made up of filter fabric such as geotextiles or any other known and/or convenient material. The filtration member prevents clogging of drainage channels. It also prevents erosion of the backfill while allowing water to drain through the drainage channels.

The blocks can also be formed in any other dimension and shape suitable for retention wall construction.

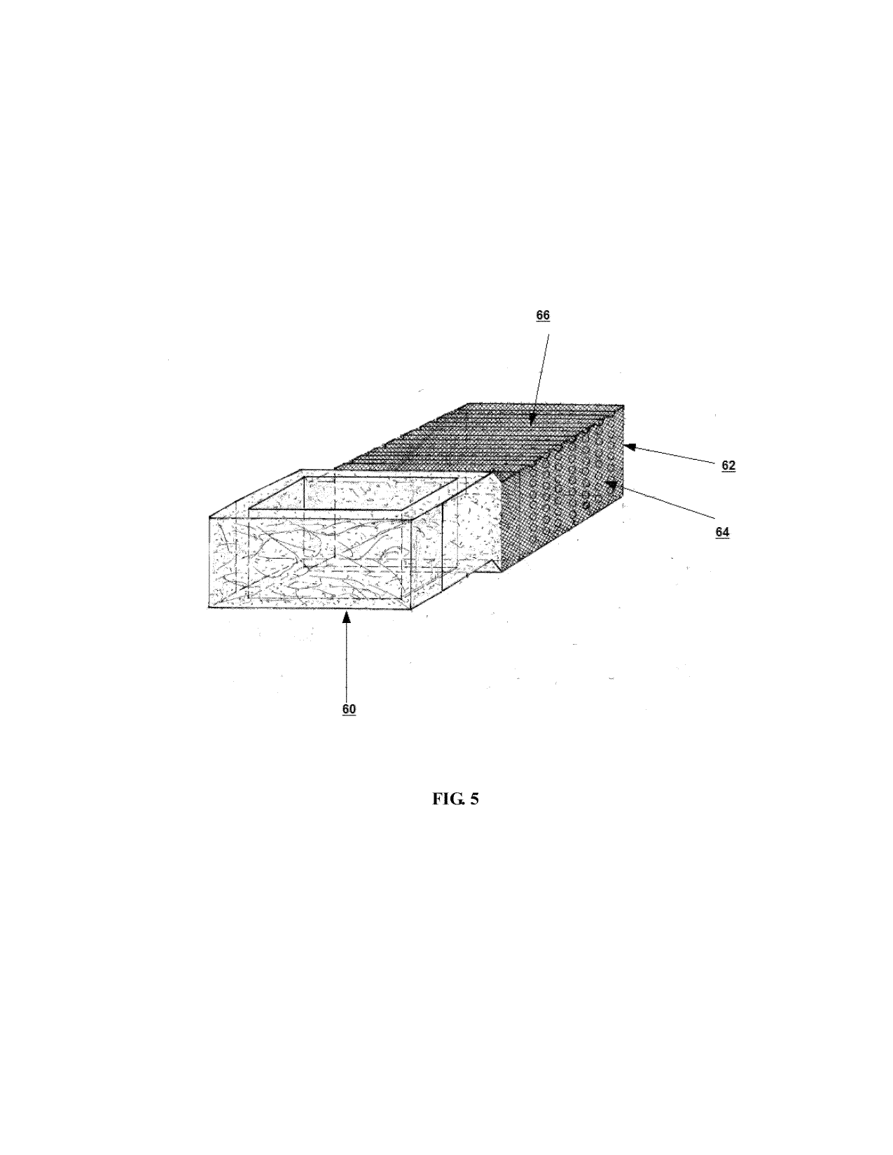

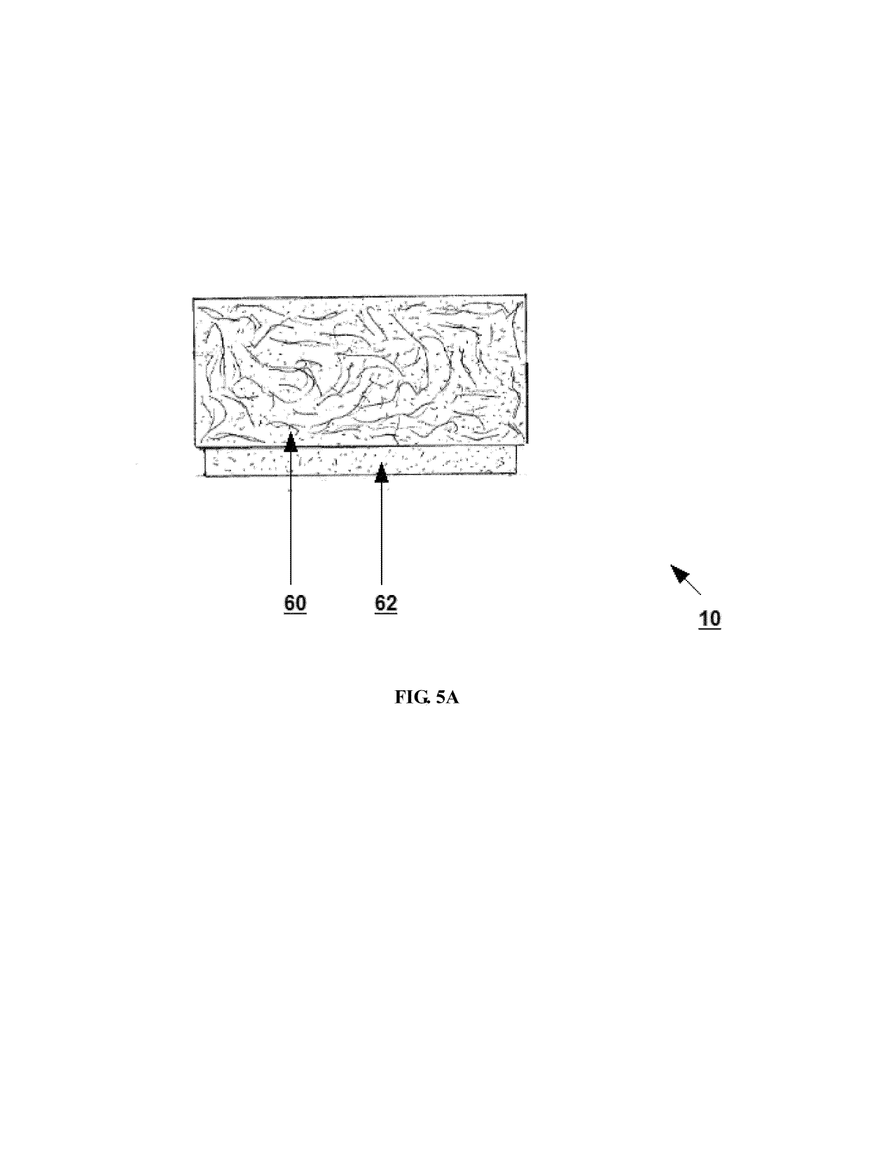

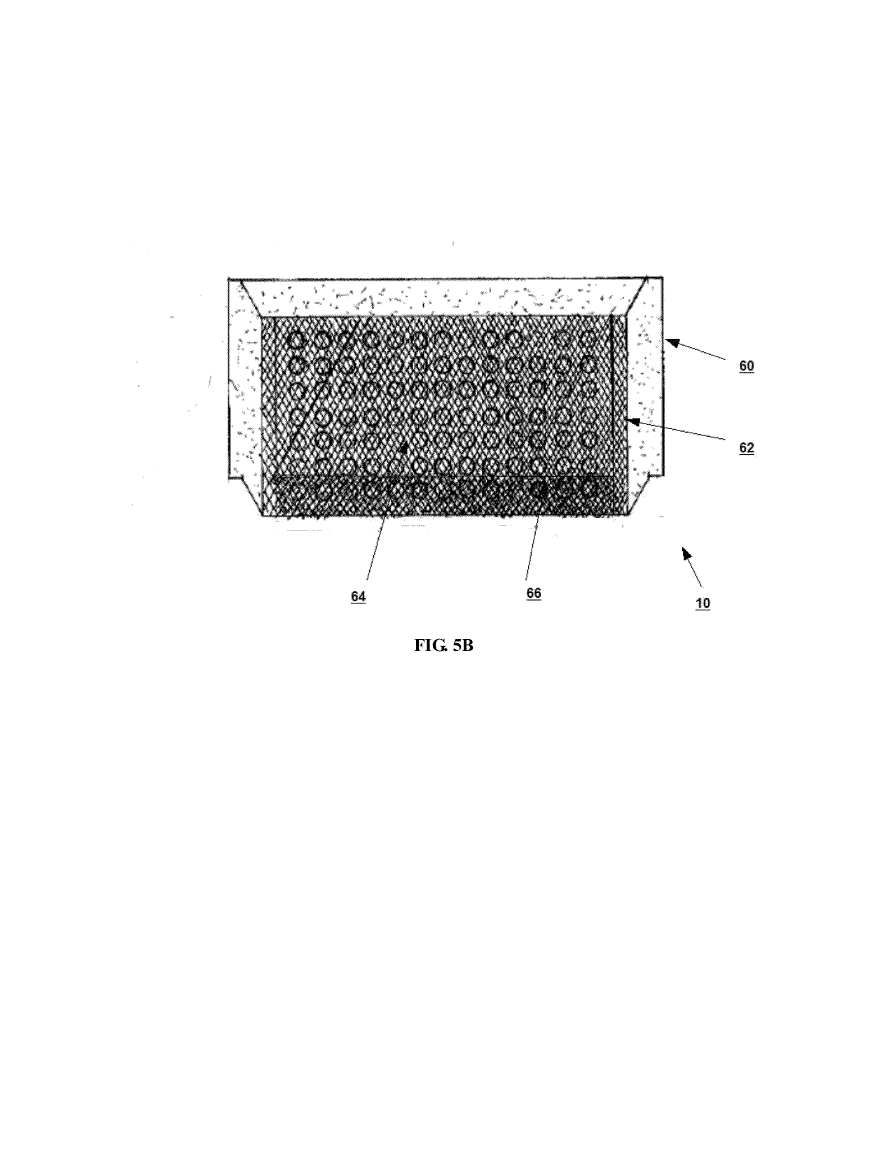

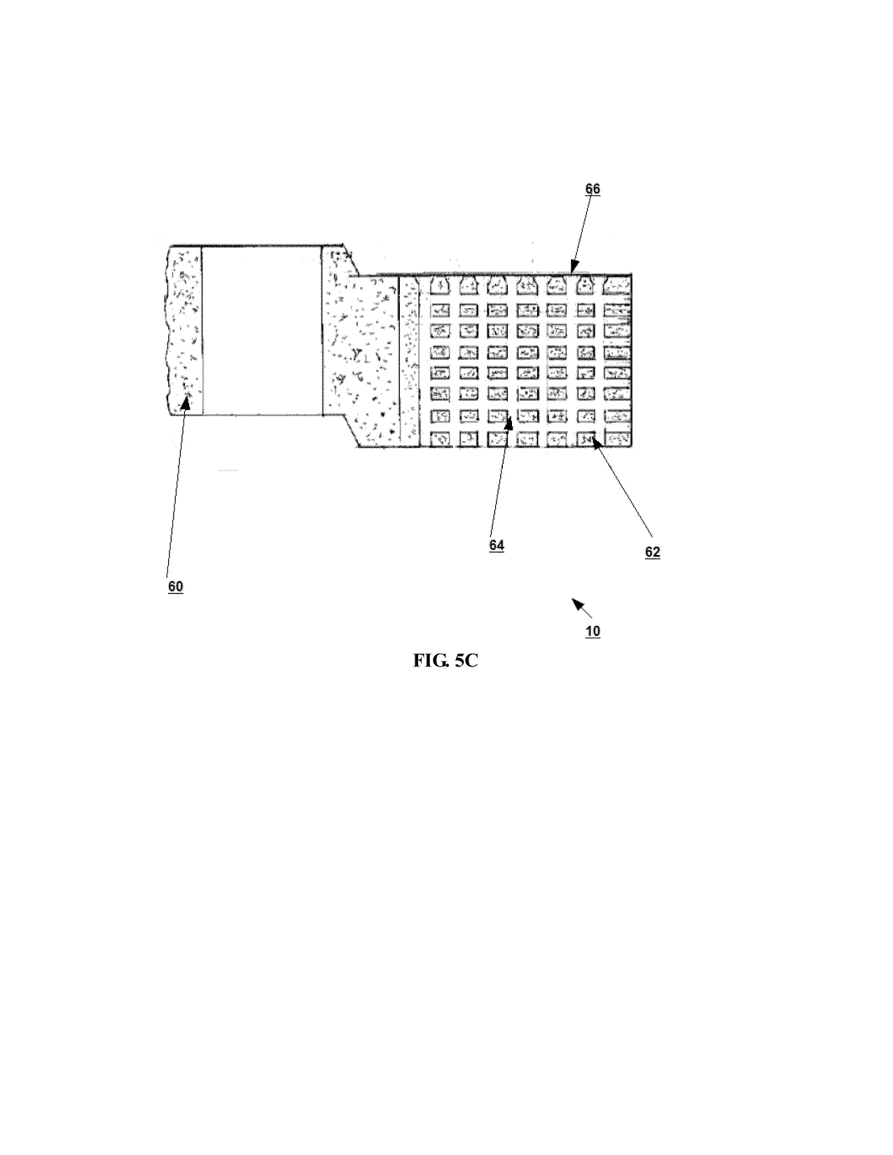

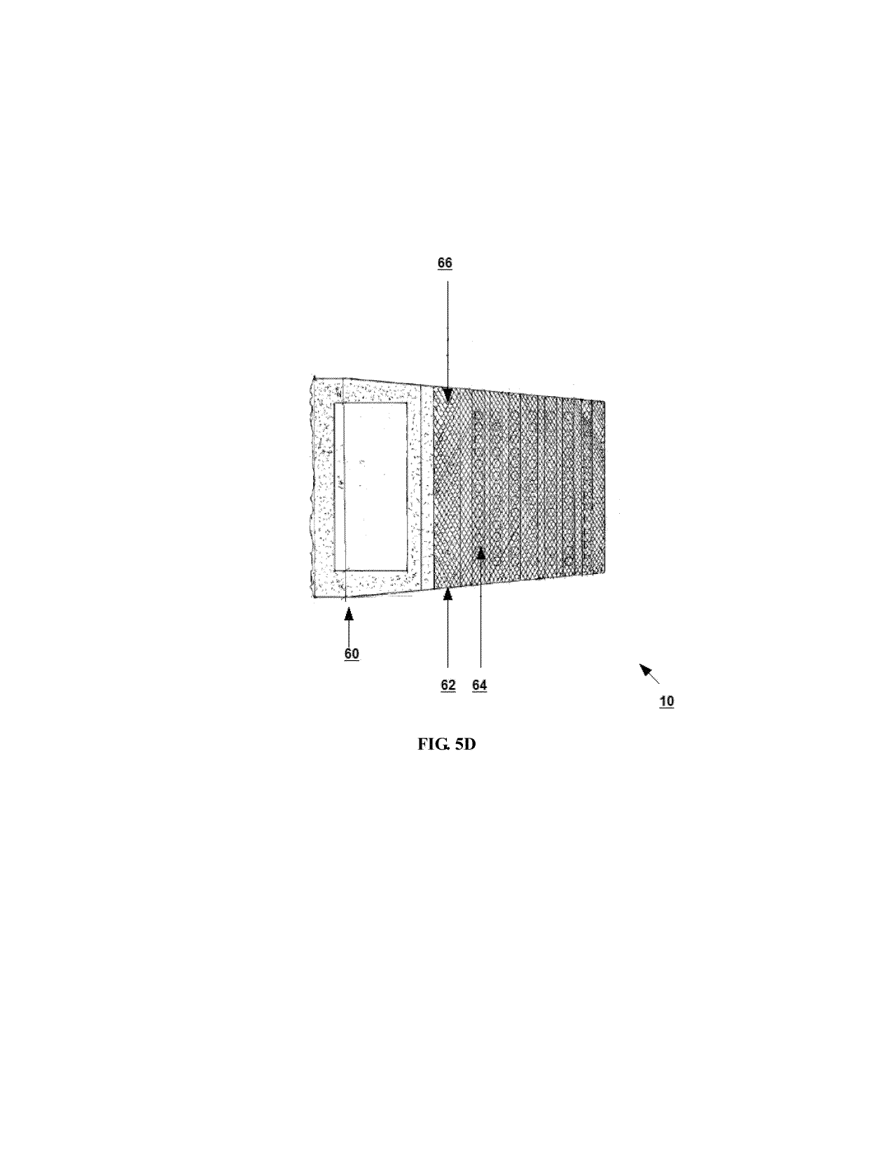

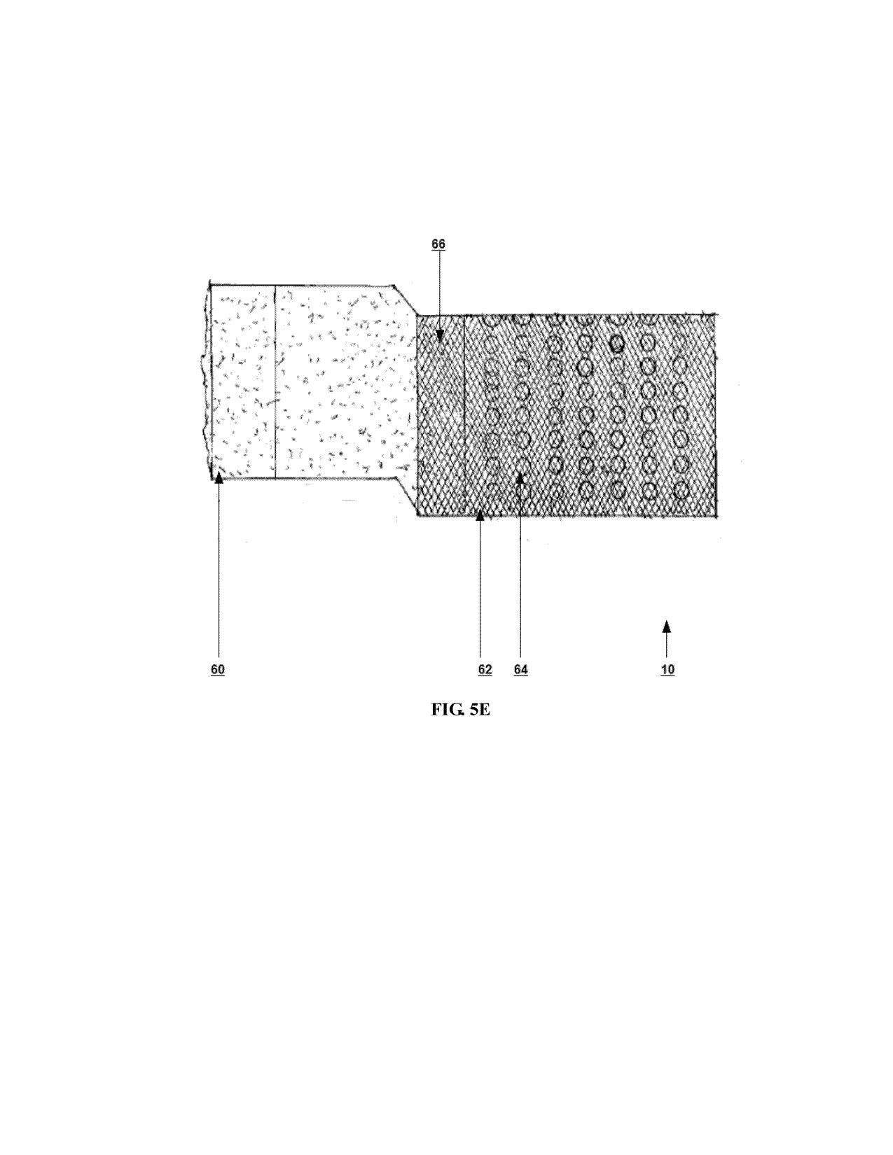

FIG. 5 illustrates a retaining wall block 10 with built in drainage and filtration capability according to another embodiment of the present device. It has a heavy member 60 made up of high-density material (e.g. manufactured stone), which can be about 18″ wide and about 12″ deep and about 8″ high. The heavy member can be made hollow with 3″ walls, in order to reduce the weight of the block. The heavy member can slope into the light member for about 1½″ of its depth, to facilitate stacking, drainage and engagement between different blocks of the retaining wall.

The heavy member 60 can be connected to a light member 62, which can be made of any light weight, water resistant material, such as polyvinyl chloride (PVC) and can be about 14″ wide, about 12″ deep and about 8″ high. One of ordinary skill in the art would appreciate that there are numerous light weight, water resistant materials that could be utilized with embodiments of the present invention, and embodiments of the present invention are contemplated for use with any such material. In a preferred embodiment, the light weight, water resistant material would be a material that is also resistant to common roadway run-off byproducts (e.g., oils, salts, sand).

The heavy member being of larger dimension can taper into the light member on all the sides. The light member can have built-in network of drainage channels 64 to facilitate drainage of water from behind the retaining wall. In the illustrated embodiment, a network of smaller channels 64 can be used for drainage. The light-weight member 62 is further covered by a filtration member 66 which can be made up of filter fabric such as geotextiles or any other known and/or convenient material. The filtration member can cover all the surfaces of the light member and prevents clogging of drainage channels. It also prevents erosion of the backfill while allowing water to drain through the drainage channels.

FIG. 5A illustrates a front elevation view of a retaining wall block 10 with built in drainage and filtration capability according to an embodiment of the present device. The heavy member 60 which can be 8″ high and 18″ wide, is seen connected to a light member 62 which can be smaller in dimension than the heavy member. The bottom surface of the heavy member can stand about 1½″ above the bottom surface of the light member and towards its end slides into the light member thus making a small step-like structure.

FIG. 5B illustrates a rear elevation view of a retaining wall block 10 with built in drainage and filtration capability according to an embodiment of the present device. The light member 62 is seen connected to the larger heavy member 60. In this embodiment, the network of small drainage channels 64 can be spread uniformly across the width of the light member 62 and can run throughout the depth of the light member. The light-weight member 62 is further covered by a filtration member 66 which can be made up of filter fabric such as geotextiles or any other known and/or convenient material. The filtration member can cover all the surfaces of the light member and prevents clogging of drainage channels.

FIG. 5C illustrates a cross-sectional view of a retaining wall block 10 with built in drainage and filtration capability according to an embodiment of the present device. The light member 62 is seen connected to the larger heavy member 60. In this embodiment, the network of small drainage channels 64 can be spread uniformly across the width as well as across the depth of the light member 62 and can run throughout the depth and height of the light member respectively, thus, providing channels for drainage of water. The light-weight member 62 is further covered by a filtration member 66. The heavy member has a hollow structure.

FIG. 5D illustrates a top elevation view of a retaining wall block 10 with built in drainage and filtration capability according to an embodiment of the present device. The light member 62 is seen connected to the larger heavy member 60. In this view, the network of small drainage channels 64 can be seen spread uniformly across the depth of the light member 62 and can run throughout the height of the light member, thus, providing channels for drainage of water. The light-weight member 62 can be further covered by a filtration member 66. The heavy member can have a hollow structure.

FIG. 5E illustrates a side elevation view of a retaining wall block 10 with built in drainage and filtration capability according to an embodiment of the present device. The small step structure between heavy member and the light member can be provided for interlocking of the blocks. The network of small drainage channels 64 are seen spread uniformly across the depth of the light member 62. The light-weight member 62 can be further covered by a filtration member 66.

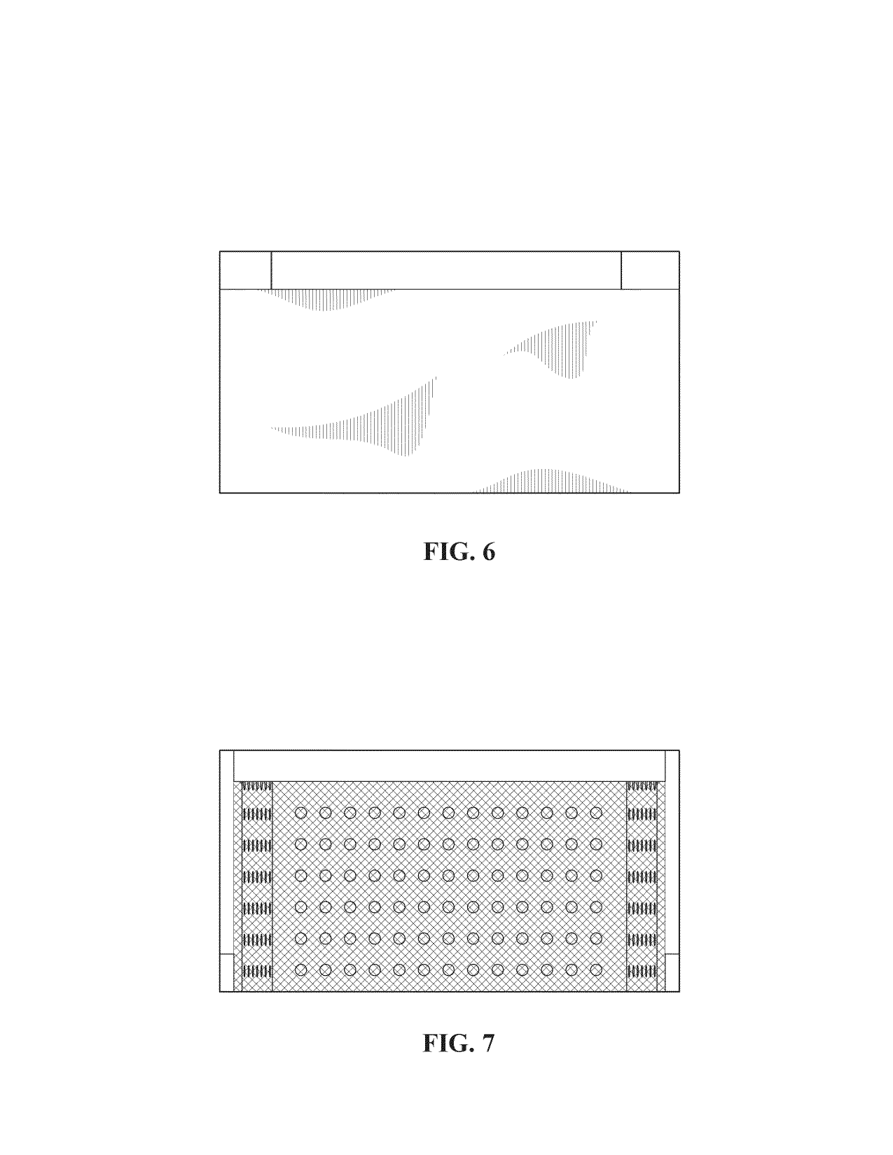

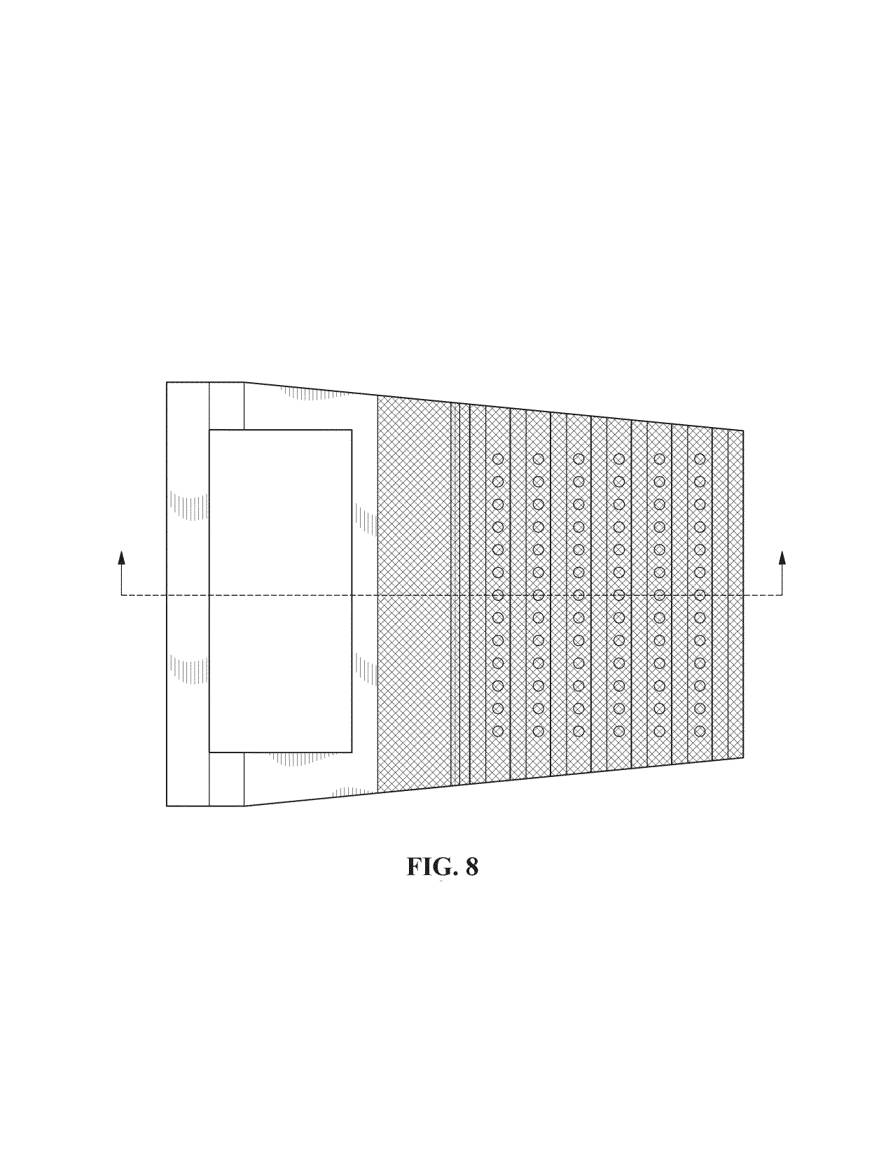

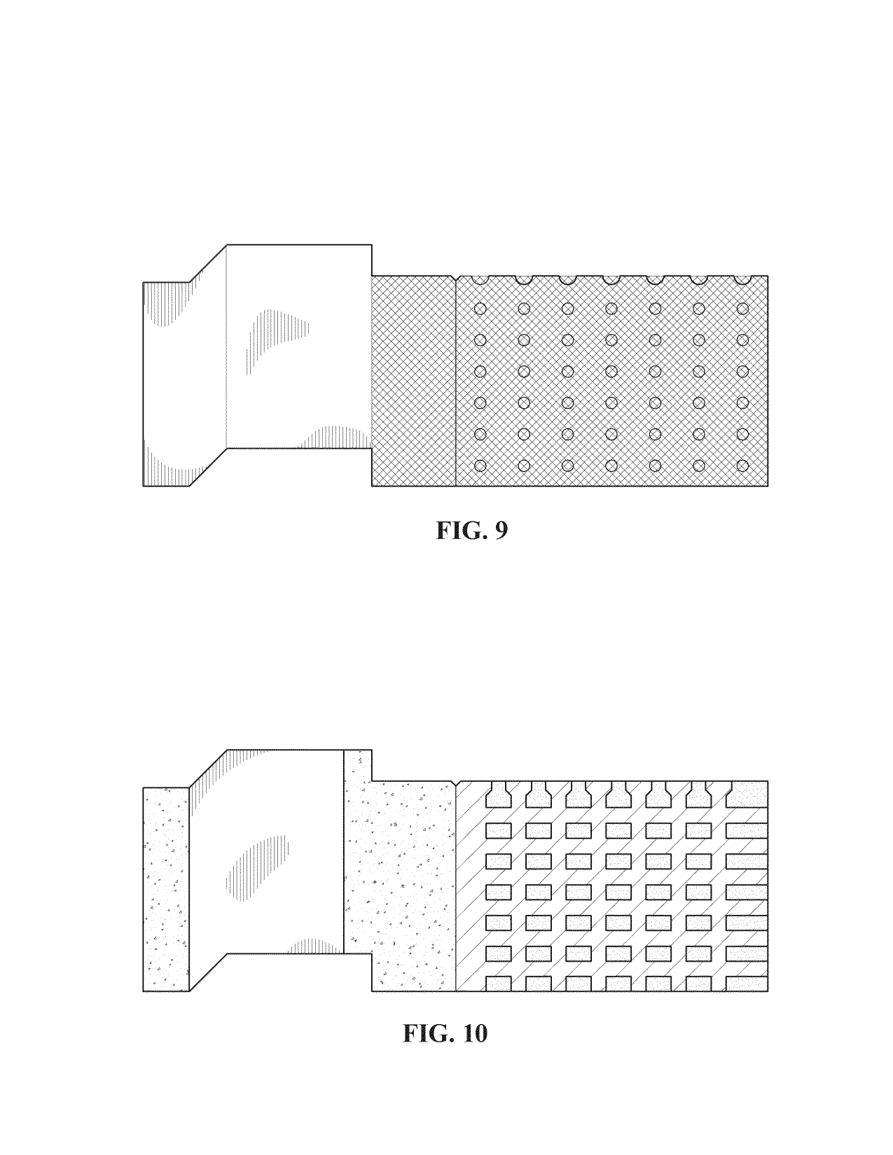

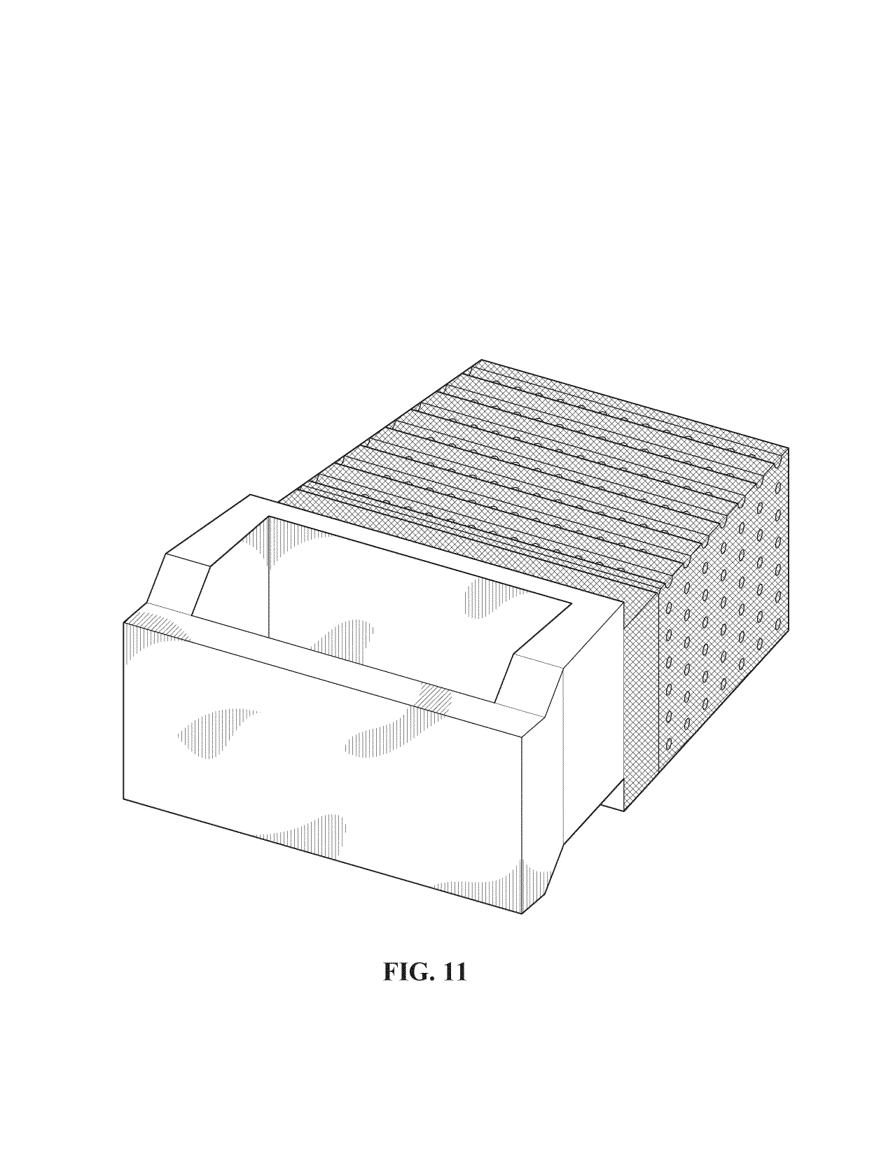

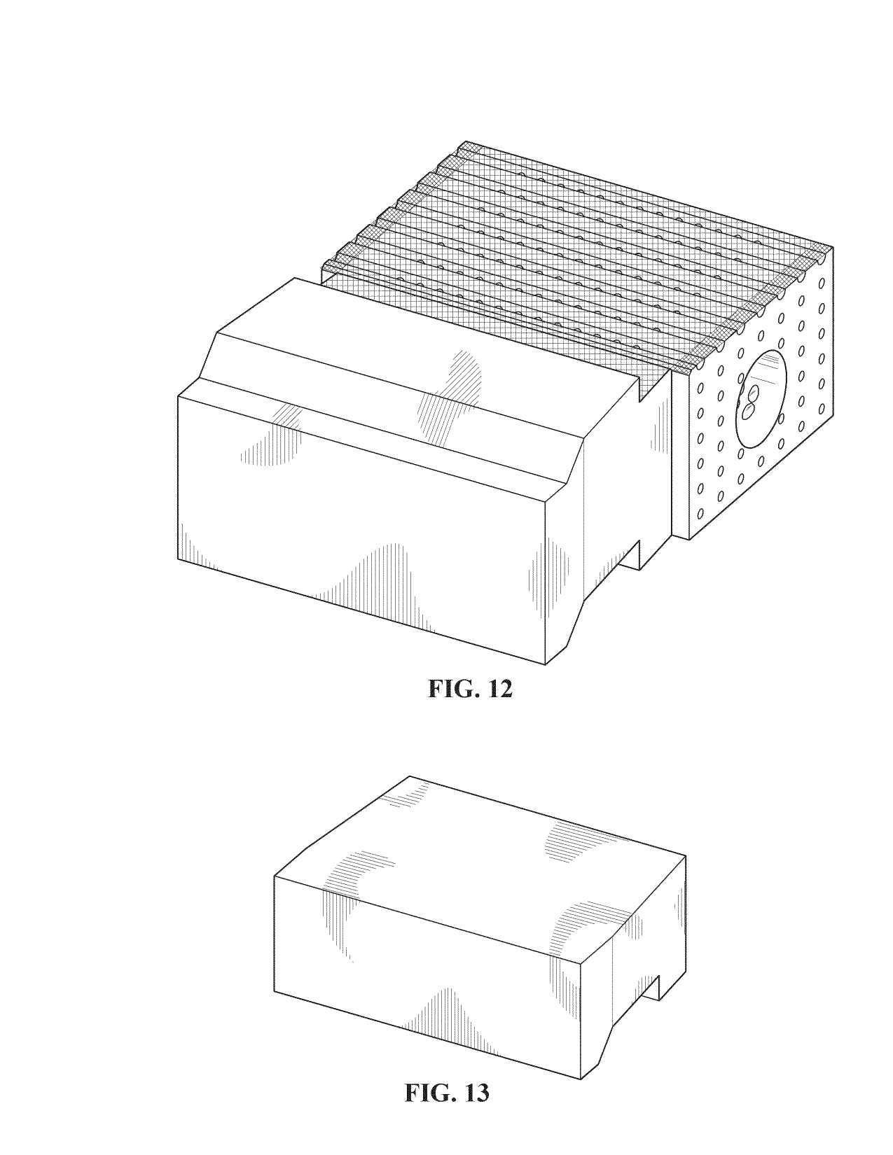

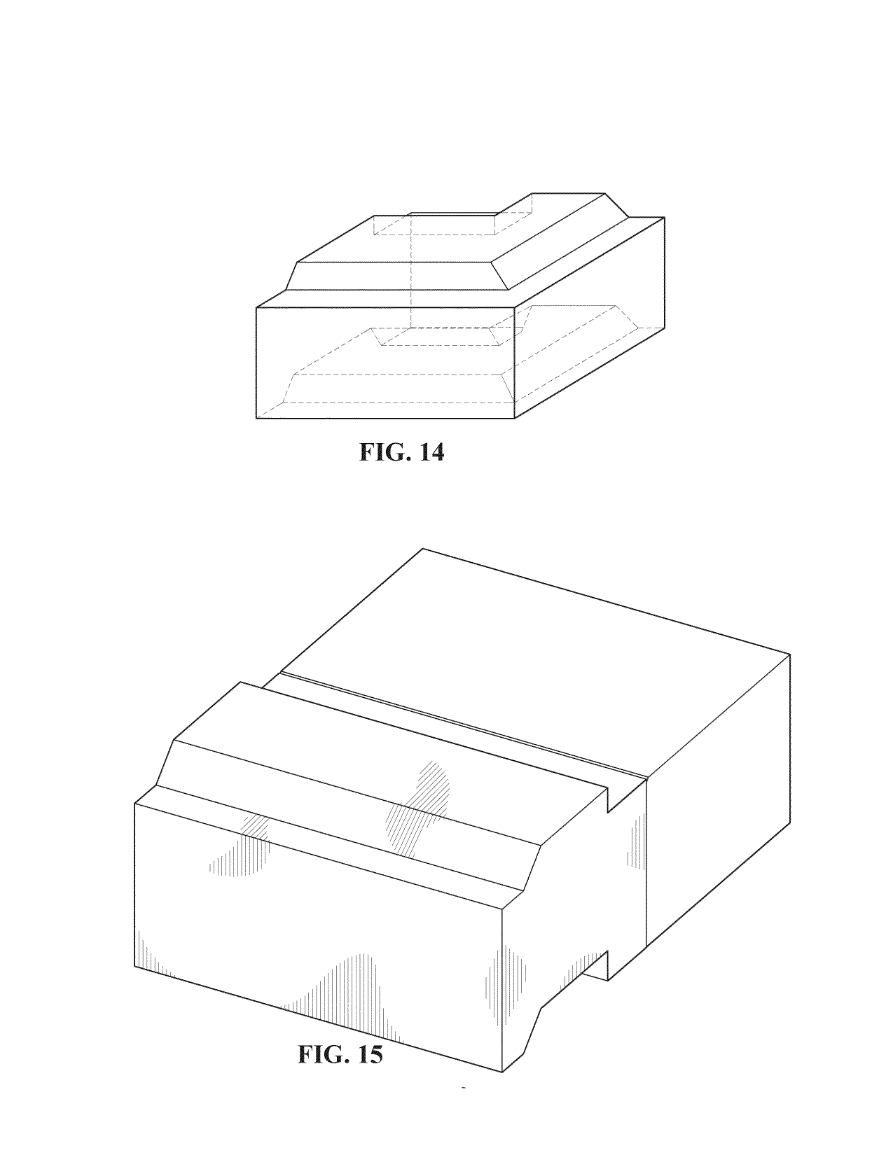

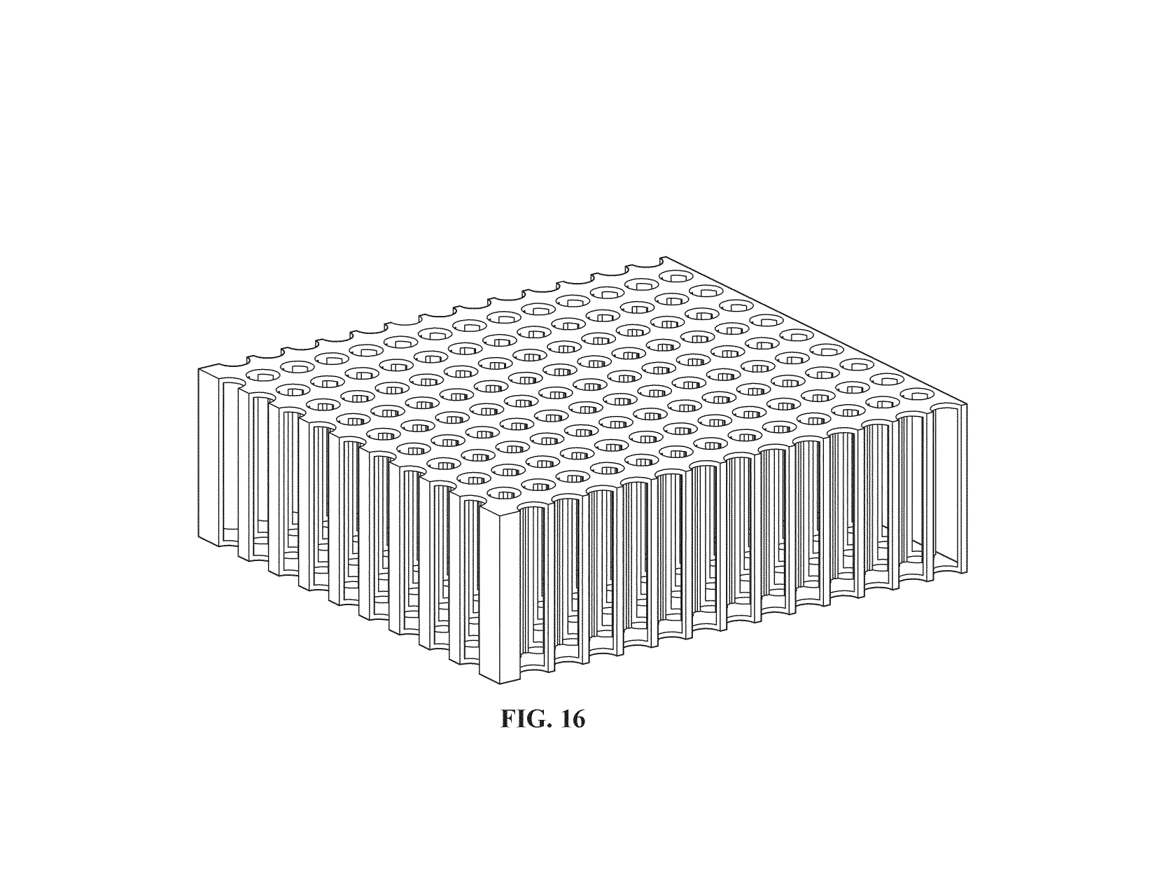

FIGS. 6-16 illustrate various views of embodiments of the present invention as substantially described above. Thus, a retaining wall block with built in drainage and filtration capabilities is disclosed. A simplified process for constructing retaining wall using these blocks is also disclosed. The block offers a simpler way to address drainage, erosion and clogging issues of retaining wall, by eliminating several retention wall creation steps. The blocks also eliminate the need for separate drainage and filtration system, they also eliminate need for free-draining aggregate backfills, thus reducing the transportation and construction cost associated with these steps. The block offers superior drainage by its network of drain channels, thus, reducing excavation and preparation costs. In the foregoing specification, the device has been described with reference to specific exemplary embodiments thereof. It will, however, be evident that various modifications and changes may be made thereto without departing from the broader spirit and scope of the device. The specification and drawings are, accordingly, to be regarded in an illustrative sense rather than a restrictive sense.

1. A retaining wall block with built-in drainage and filtration system, said retaining wall block comprising:
a heavy member, wherein said heavy member is comprised of one or more high-density materials selected from a group of high-density materials comprising, sand, gravel, cement, and stone; and
a light member, connected to said heavy member and comprising a built-in network of interconnected horizontal and vertical drainage channels, wherein said built-in network of interconnected horizontal and vertical drainage channels are configured to facilitate drainage of water,
wherein said light member comprises a light-weight, water-resistant material.

2. (canceled)

3. The retaining block with built-in drainage and filtration system of claim 1, wherein said light member comprises a material resistant to common roadway run-off and byproducts.

4. (canceled)

5. (canceled)

6. (canceled)

7. The retaining block with built-in drainage and filtration system of claim 1, wherein said built-in network of drainage channels is configured to interlink with a built-in network of drainage channels of one or more adjacent retaining blocks.

8. The retaining block with built-in drainage and filtration system of claim 1, further comprising a filtration member that covers said light member and is configured to prevent clogging of said built-in network of drainage channels.

9. The retaining block with built-in drainage and filtration system of claim 8, wherein said filtration member is further configured to prevent erosion of a backfill while allowing fluids to drain through the built-in network of drainage channels.

10. A method for building a retaining wall with built-in drainage and filtration, said method comprising the steps of:
providing a first plurality of retaining blocks,
wherein each retaining block of said first plurality of retaining blocks has a built-in drainage and filtration system,
wherein built-in drainage and filtration system is comprised of a network of interconnected horizontal and vertical channels;
engaging said first plurality of retaining blocks into a first layer,
wherein each retaining block of said first plurality of retaining blocks is engaged in a manner such that the built-in drainage and filtration system of said retaining block is engaged with at least one of the other retaining blocks of said first plurality of retaining blocks;
providing a second plurality of retaining blocks,
wherein each retaining block of said second plurality of retaining blocks has a built-in drainage and filtration system,
wherein built-in drainage and filtration system is comprised of a network of interconnected horizontal and vertical channel; and
layering one or more secondary layers onto of said first layer,
wherein said one or more secondary layers are comprised of said secondary plurality of retaining blocks,
wherein at least a portion of said retaining blocks of said second plurality of retaining blocks is layered in a manner such that the built-in drainage and filtration system of said retaining block is engaged with at least one of the other retaining blocks of said first plurality of retaining blocks,
wherein each retaining block of said second plurality of retaining blocks is engaged in a manner such that the built-in drainage and filtration system of said retaining block is engaged with at least one of the other retaining blocks of said second plurality of retaining blocks.

11. The method for building a retaining wall with built-in drainage and filtration of claim 10, further comprising the step of backfilling at least a portion of said first plurality of retaining blocks with free-draining aggregate.

12. The method for building a retaining wall with built-in drainage and filtration of claim 10, further comprising the step of backfilling at least a portion of said second plurality of retaining blocks with free-draining aggregate.

13. The method for building a retaining wall with built-in drainage and filtration of claim 10, further comprising the step of filling an area behind the retaining wall with soil.

14. The method for building a retaining wall with built-in drainage and filtration of claim 10, wherein a heavy member of each of said first plurality of retaining blocks is side-by-side engaged with a heavy member of another retaining block of said first plurality of retaining blocks.

15. The method for building a retaining wall with built-in drainage and filtration of claim 10, wherein a light member of each of said first plurality of retaining blocks is side-by-side engaged with a light member of another retaining block of said first plurality of retaining blocks.
